(19) United States
(12) Patent Application Publication
(10) Pub. No.: US 2009/0055592 A1
(43) Pub. Date: Feb. 26, 2009

(54) DIGITAL SIGNAL PROCESSOR CONTROL ARCHITECTURE

(75) Inventor: Monte Mar, Issaquah, WA (US)

Correspondence Address: Stolowitz Ford Cowger, LLP/Cypress, 621 Sw Morrison St., Suite 600, Portland, OR, 97205, US

(73) Assignee: CYPRESS SEMICONDUCTOR CORPORATION, San Jose, CA (US)

(21) Appl. No.: 12/239,450

(22) Filed: Sep. 26, 2008

Related U.S. Application Data
(63) Continuation-in-part of application No. 11/865,672, filed on Oct. 1, 2007.
(60) Provisional application No. 60/912,399, filed on Apr. 17, 2007.

(51) Int. Cl. G06F 12/00

(52) U.S. Cl. 711/125; 711/E12.001

(57) ABSTRACT

A system includes a control store memory populated with data path instructions indexable by control store addresses and jump addresses. The system further includes a control state machine to provide at least one control store address and at least one jump address to the control store memory, wherein the control store memory is configured to identify one or more data path instructions for both the control store address and the jump address.

### RELATED APPLICATIONS

This application is a continuation-in-part of co-pending U.S. application Ser. No. 11/865,672, filed Oct. 1, 2007, filed, which claims the benefit of U.S. Provisional Application No. 60/912,399, filed Apr. 17, 2007, both of which are incorporated herein by reference.

### TECHNICAL FIELD

This disclosure relates generally to electronic circuits, and more particularly to digital signal processing.

### BACKGROUND

Digital filtering is a commonly used signal processing technique that can remove unwanted parts of a digital signal, such as random noise, or extract useful parts of the digital signal, such as the components lying within a certain frequency range. Many electronic communication systems, such as radios, cell phones, and stereo receivers, include digital signal processors that can perform digital filtering, such as Finite Impulse Response (FIR) filtering or Infinite Impulse Response (IIR) filtering.

These digital signal processors are often preconfigured with instructions that, when sequentially executed, can filter digital data signals. The instructions can include conditional instructions, i.e., such as conditional branches or jumps, that have multiple potential next instructions. When the digital signal processors encounter a conditional instruction, they resolve the condition to determine the next instruction to execute. When the next instruction is not sequentially located, however, there is a delay in locating the next instruction, thus creating a throughput bottleneck for the digital signal processors.

### SUMMARY

According to an embodiment, a device comprising a first control store memory device populated with data path instructions that are indexable by control store addresses, wherein the first control store memory device is configured to locate a first set of one or more data path instructions corresponding to at least one control store address. The device further comprises a second control store memory device populated with data path instructions that are indexable by the conditional addresses, wherein the second control store memory device is configured to locate a second set of one or more data path instructions corresponding to at least one conditional address. The device further comprises a selection circuit to select between the first set of data path instructions and the second set of data path instructions, wherein the selected set of data path instructions, when executed, are configured to direct digital signal processing operations.

According to an embodiment, a method comprises receiving at least one control store address and at least one conditional address from a control state machine, locating a first set of data path instructions in a first control store memory device according to the control store address, locating a second set of data path instructions in a second control store memory device according to the conditional address, and selecting between the first set of data path instructions and the second set of data path instructions, wherein the selected set of data path instructions, when executed, are configured to direct digital processing operations.

According to an embodiment, a system comprises a control store memory populated with multiple sets of data path instructions indexable by control store addresses and jump addresses. The system further comprises a control state machine to provide at least one control store address and at least one jump address to the control store memory, wherein the control store memory is configured to identify a first set of data path instructions according to the control store address and a second set of data path instructions according to the jump address. The system further comprises a data path device to perform digital processing operations on digital data according to one of the first set of data path instructions identified by the control store address or the first set of data path instructions identified by the jump address.

### DESCRIPTION OF THE DRAWINGS

The invention may be best understood by reading the disclosure with reference to the drawings.

FIG. 1 is a block diagram of an example programmable mixed-signal system on a chip including a digital filtering system according to embodiments of the invention.

FIG. 2 is a block diagram illustrating example embodiments of the digital signal processor shown in FIG. 1.

FIG. 3 is a block diagram illustrating example embodiments of a processor controller shown in FIG. 2.

FIG. 4 is a block diagram illustrating example embodiments of a control store memory shown in FIGS. 2 and 3.

FIG. 5 is an example flowchart for the operation of the processor controller shown in FIGS. 1-4.

### DETAILED DESCRIPTION

A programmable system on a chip (PSOC) or other electronic devices include a digital signal processor to processes digital signals. The digital signal processor can include a divided control store memory that allows the digital signal processor to identify multiple instruction sets in parallel when a conditional decision in encountered, thus allowing the digital signal processor the ability to seamlessly branch or jump between instruction sets and process the digital signals. Embodiments are shown and described below in greater detail.

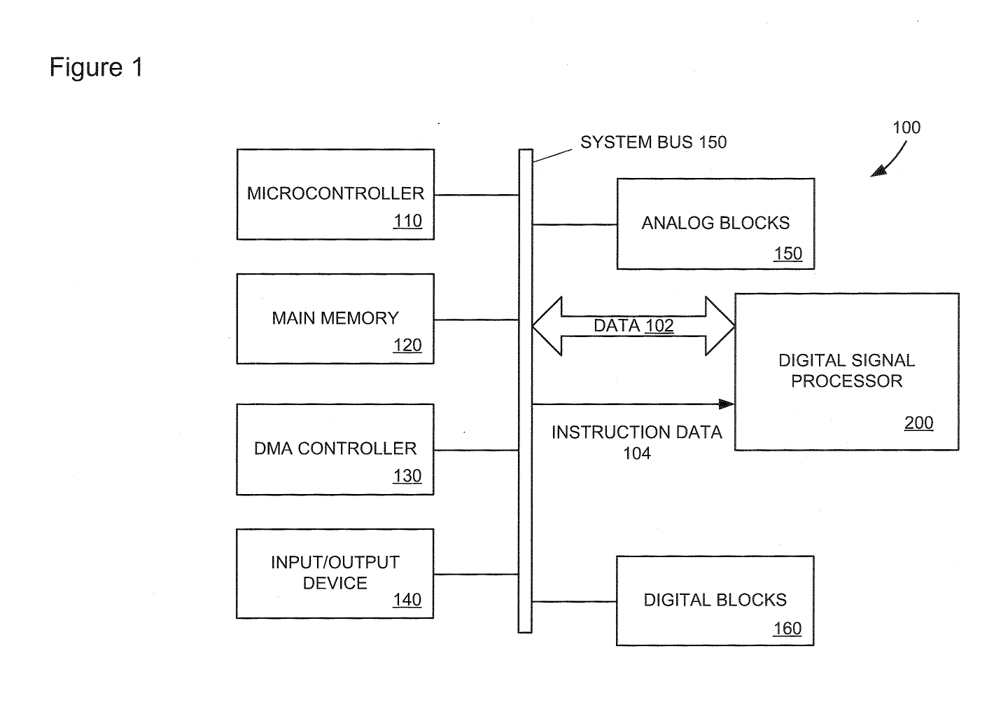

FIG. 1 is a block diagram of an example programmable system on a chip 100 including a digital signal processor 200 according to embodiments of the invention. Referring to FIG. 1, the programmable system on a chip 100 can be a mixed-signal system comprising a system bus 150 that communicatively couples multiple electronic components (both analog and digital), such as a microcontroller 210, a main memory 120, direct memory access (DMA) controller 130, Input Output (I/O) device 140, one or more analog blocks 150, such as analog-to-digital converters (ADCs) and digital-to-analog converters (DACs), one or more digital blocks 160, and a digital signal processor 200. In some embodiments, additional electronic components can be coupled to the system bus 150 and/or some of the electronic components shown in FIG. 1 can disconnected from the system bus 150.

The digital signal processor 200 is reconfigurable to implement various digital signal processing algorithms, such as a Finite Impulse Response (FIR) filter, a Biquad Infinite Impulse Response (IIR) filter, Lattice Wave Digital (LWDF) filter, among others. The digital signal processor 200 includes a system interface to communicate with the other blocks in the programmable system 100 and to receive algorithm or instruction data 104 in the form of instructions from the system bus 150. The digital signal processor 200 can execute the instructions to implement one or more digital signal processing algorithms or processes. For instance, the instructions data 104 can include various coefficients and instructions that, when loaded and initialized into the digital signal processor 200, can prompt the digital signal processor 200 to implement different digital signal processing algorithms or processes, such as a digital filter for data 102. In some embodiments, the instruction data 104 can be stored in the main memory 120 and the microcontroller 110 can provide the instruction data 104 to the digital signal processor 200.

In other words, the digital signal processor 200 can receive a series of instructions implementing a digital signal processing operation, such as a digital filter for received data 102. This series of instructions can be programmed or loaded once and later reconfigured by a microcontroller 110. The reconfigurability of the digital signal processor 200 allows the programmable system on a chip 100 the ability to maintain a wide array of digital signal processing functionality without the corresponding consumption of system resources, such as memory and processing. The architecture of the digital signal processor 200 can include multiple memory devices that are scalable, allowing for a compact implementation that is amenable to integration in one or more processors on the chip. Embodiments of the digital signal processor 200 will be described below in greater detail.

The digital signal processor 200 can receive data 102 from the system bus 150 and then apply an algorithm to data 102 according to its current configuration. There are many ways for the programmable system on a chip 100 to provide or stream the data 102 to the digital signal processor 200. For instance, the main system processor 110 can access the data 102 stored in the main memory 120 and send or stream it to the digital signal processor 200. In another example, the DMA controller 130 can directly retrieve and provide or stream the data 102 from one or more of the electrical components coupled to the system bus 105.

The I/O device 140 can receive analog or digital signals, for example, from a microphone or a network, and provide them to the main memory 120 or other storage device in the programmable system on a chip 100. In some embodiments, the I/O device 140 can provide received analog signals to an analog-to-digital converter (not shown) to convert the analog signals into digital signals for subsequent digital filtering. The DMA controller 130 can directly transfer these converted digital signals to the digital signal processor 200 as data 102 for digital filtering.

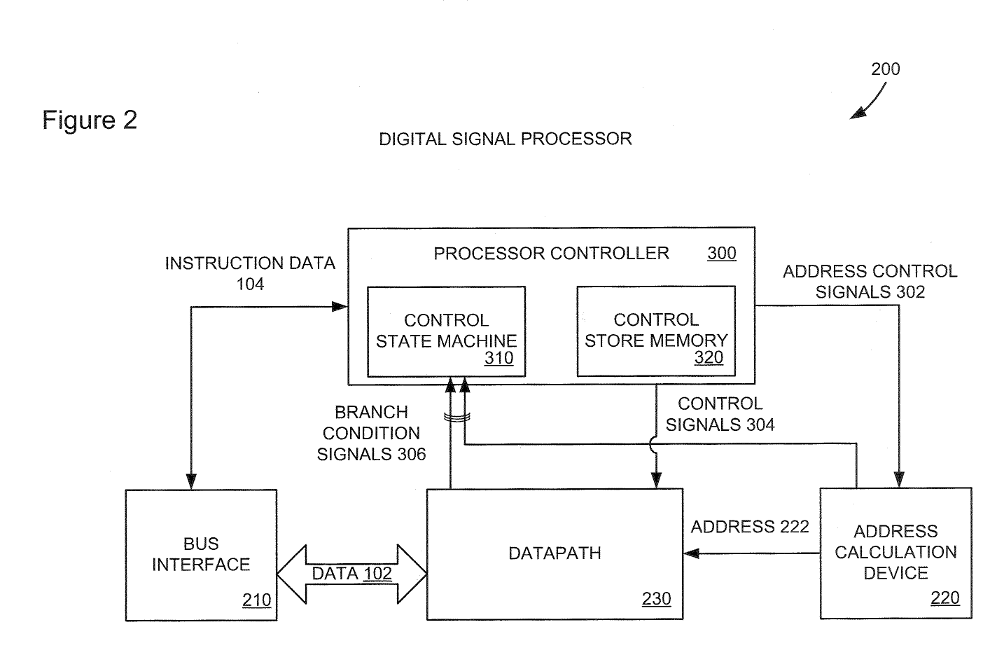

FIG. 2 is a block diagram illustrating example embodiments of the digital signal processor 200 shown in FIG. 1. Referring to FIG. 2, the digital signal processor 200 includes a bus interface 210 to exchange data with the system bus 150 of the programmable system on a chip 100. The digital signal processor 200 also includes a data path 230 to perform mathematical operations on the data 102 received by the bus interface 210, and includes a processor controller 300 to control or direct the operations of the data path 230.

The processor controller 300 and the data path 230 can be loaded or configured to, at least in part, implement one or more digital signal processing algorithms according to the instruction data 104. In some embodiments, the data path 230 can load various coefficients used in implementing specific digital filters from the instruction data 104, while the processor controller 300 can load various data path instructions that both direct configuration of the data path 230 and identify which coefficients the data path 230 is to utilize during the signal processing operations.

The processor controller 300 can be implemented as a hierarchical controller that allows complex branching to be implemented. Rather than using long sequential instruction sets, the data path instructions can be grouped in loops, subroutines, or multi-way branches in control flow. This hierarchical structure can enable the digital signal processor 200 to incorporate reduced-size memory devices to store the groups of data path instructions, thus allowing for a smaller overall implementation of the digital signal processor 200. For example, an Infinite Impulse Response (IIR) filter can be implemented using a basic building block called a biquad. The above architectural features enable scalability of the digital signal processor 200, and allow one or more processors to be integrated on a single die with analog and digital circuit blocks to comprise a mixed signal PSoC device.

The processor controller 300 can provide control signals 304 to the data path 230 and one or more address calculation devices 220 according to the instructions loaded in the processor controller 300. The control signals 304 prompt the data path 230 and address calculation devices 220 to implement at least one digital signal processing algorithm or process. In some embodiments, the control signals 304 direct the flow of the data 102 through the data path 230, e.g., by establishing which mathematical and/or logical functions are utilized to manipulate the data 102 during digital signal processing and what signals or data 102 is inputted into the selected mathematical and/or logical functions. When the data 102 is received with a fixed width, the digital signal processor 200 can be a fixed word length processor. Thus, when using a binary point, floating point arithmetic can be emulated by the digital signal processor 200.

The processor controller 300 can also provide address control signals 302 to address calculation devices 220 according to the data path instructions. The address control signals 302 can identify one or more addresses 222 stored in the address calculation devices 220. The addresses 222, when provided to the data path 230, can identify coefficients that the data path 230 can use when digitally filtering the data 102 from the bus interface 210. The combination of the control signals 304 and the address control signals 302 can control the operation of the data path 230 to implement various digital signal processing algorithms and to digitally filter the data 102 from the bus interface 210.

In some embodiments, the data path 230 and address calculation device 220 can be pipelined in a fashion to allow calculation of consecutive multiply accumulate operations. The interaction with the processor controller 300, the address calculation device 220, and the data path 230 can allow branches in the program flow to occur. In some embodiments, the processor controller 220 can allow branching with pipeline latencies of 0, 1, and 2 cycles depending on the branch condition.

The processor controller 300 includes a control state machine 310 and a control store memory 400 that, in combination, can control or direct the operations of the data path 230. The control store memory 400 can be loaded with one or more data path instructions that, when identified by the control state machine 310, can prompt the processor controller 300 to output the control signals 304 and the address control signals 302.

The control state machine 310 can receive branch condition signals 306 from the data path 230 and the address calculation device 220. The branch condition signals 306 can indicate to the control state machine 310 the outcome of a branching condition presented by an executed data path instruction. In some embodiments, the control state machine 310 can utilize the branching condition signals 306 to determine which data path instruction set to select for execution next. Embodiments of the processor controller 300 will be described below in greater detail.

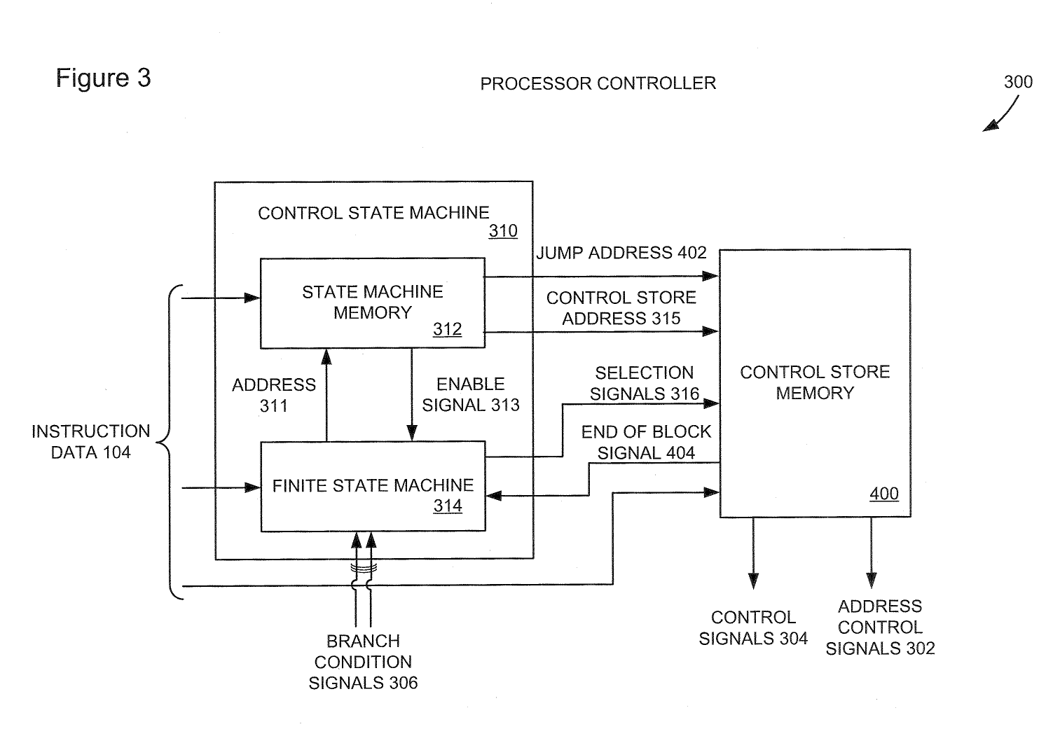

FIG. 3 is a block diagram illustrating example embodiments of a filtering controller 300 shown in FIG. 2. Referring to FIG. 3, the processor controller 300 can receive instruction data 104 from the bus interface 210 and reconfigure both the control state machine 310 and the control store memory 400 for various digital signal processing operations.

The control state machine 310 can include a state machine memory 312 and a finite state machine 314 that can be programmed with instruction data 104. For instance, the instruction data 104 can provide the finite state machine with addresses 311 and can populate the state machine memory 312 with control store addresses 315. In some embodiments, a random access memory (RAM) is used to implement both the state machine memory 312 and finite state machine 314. The use of RAM allows the control state machine 310 to be reconfigurable or reprogrammable, for example, by the microcontroller 110.

The finite state machine 314, when initiating a next state of a process, can provide one or more addresses 311 to the state machine memory 312. The addresses 311 can be used to index or address the state machine memory 312 and identify one or more control store addresses 315. Once identified, the state machine memory 312 can provide the control store addresses 315 to the control store memory 400 for use in identifying sets of one or more data path instructions.

The finite state machine 314 can also receive input from various sources in the digital signal processor 200, and utilize the input to direct its operation. For instance, the state machine memory 312 can provide the finite state machine 314 with additional information, such as enable bits or signals 313, which can help determine the next state to perform. In some embodiments, the finite state machine 314 can proceed to another state of digital filtering process upon receipt of an end of block signal 404 provided by the control store memory 400. The data path 230 and the address calculation device 220 can provide branch condition signals 306 to the finite state machine 314 to determine a result of a condition presented during execution of a data path instruction. In some embodiments, as will be discussed below in greater detail, the finite state machine 314 can direct the control store memory 400 to select a next instruction set based, at least in part, on the branch condition signals 306.

The control store memory 400 can store sets of data path instructions that, when identified, control signal processing operations in the digital signal processor 200. Since the data path instructions can be configured into modular groups of instructions, the control state machine 310 provides the control store addresses 315 to switch between these modular groups or data path instruction sets. In some embodiments, the control store memory 400 will issue an end of block signal 404 to the finite state machine 314 to indicate that an end of a data path instruction set is approaching or has been reached. The finite state machine 314 can then identify at least one address 311 to send to the state machine memory 312 to identify a control store address 315 that, when provided to the control store memory 400, can identify a next set of data path instructions to execute.

In some instances, there can be multiple options for the next set of data path instruction, such as when a conditional branch or jump instruction appears in the previous instruction set. Since the finite state machine 314 does not initially know which instruction set is to be the next instruction set executed, in some embodiments, the finite state machine directs the state machine memory 312 to provide multiple control store addresses, e.g., one control store address 315 and one jump address 402. The control store memory 400 can process these addresses in parallel, so that once the correct option is determined, for example, through the evaluation of the condition in the conditional branch or jump instruction in the previous instruction set as indicated by the branch condition signals 306 from the data path 230 and/or the address calculation device 220, the next data path instruction set is ready to be executed.

The finite state machine 314 can issue selection signals 316 to the control store memory 400 that direct the selection between the multiple available data path instruction sets. In some embodiments, the finite state machine 314 can issue selection signals 316 to the control store memory 400 in response to the end of block signal 404 or other input, such as the branch condition signals 306 indicating a result of a condition received from the data path 230 or the address calculation unit 220. By identifying multiple potential next instruction sets in parallel, the digital signal processor 200 can seamlessly transition between multiple data path instruction sets without substantial delay. This ability to branch seamlessly coupled with the dynamic reconfigurability of the PSoC system provides the foundation for being able to divide complex algorithms into multiple modular groups of code, such as data path instruction sets, which enables system designers to reduce memory size and overall system size.

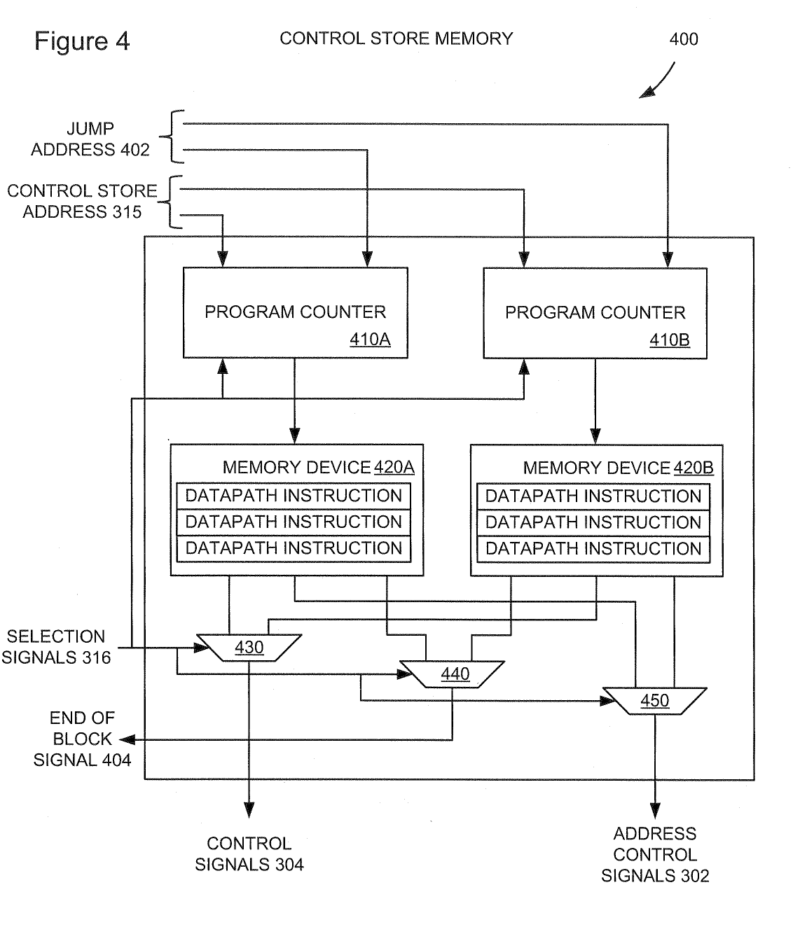

FIG. 4 is a block diagram illustrating example embodiments of a control store memory 400 shown in FIG. 2. Referring to FIG. 4, the control store memory 400 can include multiple memory devices 420A and 420B to store data path instruction sets. These memory devices 420A and 420B can be addressed or are indexable by control store addresses 315 and jump addresses 402 provided to the control store memory 400 by the control state machine 310. The data path instructions, once identified responsive to the control store addresses 315 or the jump addresses 402, prompt the control store memory 400 to provide control signals 304 to the data path 230 and provide address control signals 302 to the address calculation devices 220. In some embodiments, the memory devices 420A and 420B is a random access memory (RAM). The use of RAM allows the control state machine 310 to be reconfigurable or reprogrammable, for example, by the microcontroller 110 with instruction data 104.

The control store memory 400 can include multiple program counters 410A and 410B to receive at least one of the control store addresses 315 and jump addresses 402 from the control state machine 310, and utilize them to identify data path instruction sets stored in the memory devices 420A and 420B, respectively. The control store addresses 315 and the jump addresses 402 can identify a starting point of a set of data path instructions to be sequentially executed until an end of block signal 404 is reached. Although FIG. 4 shows two memory devices 420A and 420B and two program counters 410A and 410B, in some embodiments, any number of memory devices and program counters can be introduced or utilized in the control store memory 400.

In some embodiments, each program counter 410A and 410B can receive both the control store address 315 and jump address 402 from the control state machine 310, and then select one of them to locate data path instruction sets stored in respective memory devices 420A and 420B according to the selection signals received from the finite state machine 314. For instance, the program counters 410A and 410B can include one or more multiplexers (not shown) that provide one of the control store address 315 or jump address 402 the respective memory devices 420A and 420B.

In some embodiments, the state machine memory 314 can selectively send the program counters 410A and 410B one of the control store address 315 and jump address 402, respectively. This informed process for distributing control store address 315 and jump address 402 to the program counters 410A and 410B could eliminate the need for any selection circuitry in the program counter 410A and 410B and routing for the selection signals 316.

The control store memory 400 includes several multiplexers 430, 440, and 450 to determine which of the data path instruction sets will be provided to the rest of the digital signal processor 200 and control signal processing operations. Since each memory device 420A and 420B outputs a data path instruction set corresponding to different addresses, i.e., the control store address 315 and the jump address 402, the addition of the multiplexers 430, 440, and 450, allows the control store memory 400 to determine or select which one of the sets should be executed.

The multiplexer 430 receives at least a portion of the data path instruction sets from both of the memory devices 420A and 420B, and then selects one of them for distribution to the data path 230 as control signals 304. The multiplexer 440 receives at least a portion of the data path instruction sets from both of the memory devices 420A and 420B, and then selects one of them for distribution to the finite state machine 314 as the end of block signal 404. The multiplexer 450 receives at least a portion of the data path instruction sets from both of the memory devices 420A and 420B, and then selects one of them for distribution to the address calculation device 220 as the address control signals 302.

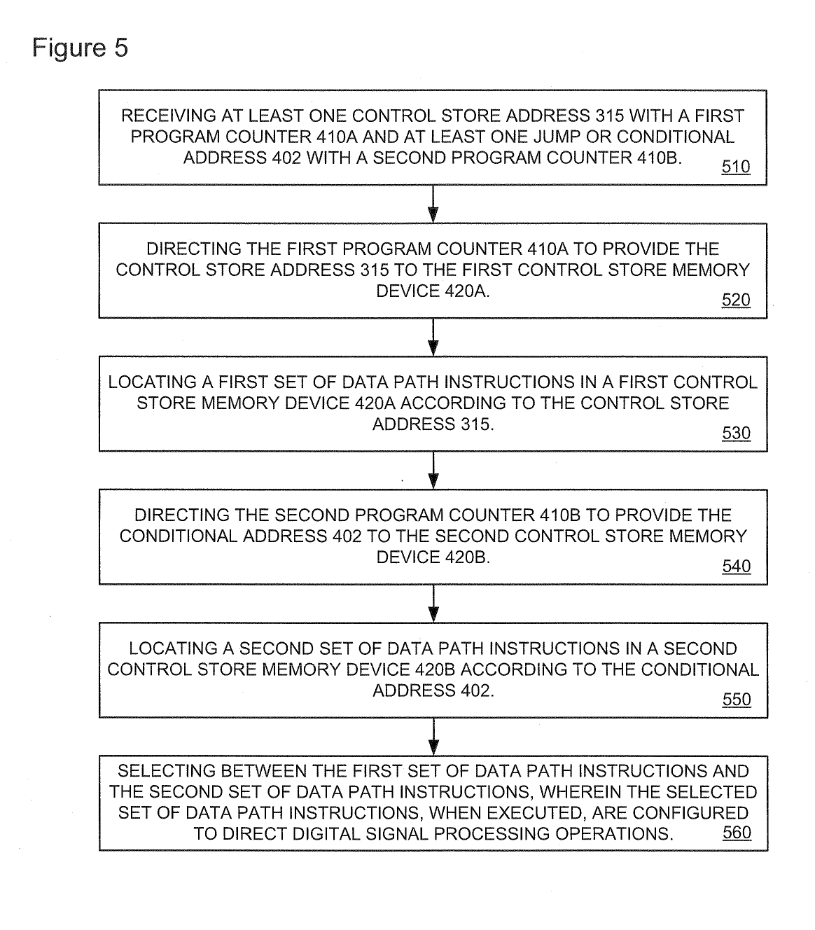

FIG. 5 is an example flowchart for the operation of the processor controller 300 shown in FIGS. 1-4. Referring to FIG. 5, at a block 510, the control store memory 400 receives at least one control store address 315 with a first program counter 410A and at least one jump or conditional address 402 with a second program counter 410B. The control store address 315 and conditional address 402 can be provided to the control store memory 400 from the control state machine 310. In some embodiments, the state machine memory 312 provides the control store address 315 and conditional address 402 to the program counters 410A and 410B responsive to one or more addresses 311 from the finite state machine 314.

At blocks 520 and 530, the control store memory 400 directs the first program counter 410A to provide the control store address 315 to the first control store memory device 420A, and locates a first set of data path instructions in a first control store memory device 420A according to the control store address 315. In some embodiments, the first program counter 410A provides the control store address 315 to the first control store memory device 420A responsive to selection signals 316 from the finite state machine 314.

At blocks 540 and 550, the control store memory 400 directs the second program counter 410B to provide the conditional address 402 to the second control store memory device 420B, and locates a second set of data path instructions in a second control store memory device 420B according to the conditional address 402. In some embodiments, the second program counter 410B provides the conditional address 402 to the second control store memory device 420B responsive to selection signals 316 from the finite state machine 314.

As discussed above, both program counters 410A and 410B can be configured to receive both the control store address 315 and the conditional address 402. The control state machine 310 can then provide selection signals 316 to the program counters 410A and 410B to indicate which address should be provided to the respective memory device 420A and 420B.

At a block 560, the control store memory 400 selects between the first set of data path instructions and the second set of data path instructions, wherein the selected set of data path instructions, when executed, are configured to direct digital signal processing operations. This selection can be performed with one or more multiplexers 430, 440, and 450, in the control store memory 400. In some embodiments, multiplexer 430 receives at least a portion of the data path instruction sets from both of the memory devices 420A and 420B, and then select one of them for distribution to the data path 230 as control signals 304. Multiplexer 440 can receive at least a portion of the data path instruction sets from both of the memory devices 420A and 420B, and then select one of them for distribution to the finite state machine 314 as the end of block signal 404. Multiplexer 450 can receive at least a portion of the data path instruction sets from both of the memory devices 420A and 420B, and then select one of them for distribution to the address calculation device 220 as the address control signals 302.

One of skill in the art will recognize that the concepts taught herein can be tailored to a particular application in many other advantageous ways. In particular, those skilled in the art will recognize that the illustrated embodiments are but one of many alternative implementations that will become apparent upon reading this disclosure.

The preceding embodiments are exemplary. Although the specification may refer to “an”, “one”, “another”, or “some” embodiment(s) in several locations, this does not necessarily mean that each such reference is to the same embodiment(s), or that the feature only applies to a single embodiment.

1. A device comprising:
a first control store memory device populated with data path instructions that are indexable by control store addresses, wherein the first control store memory device is configured to locate a first set of the data path instructions corresponding to at least one control store address;
a second control store memory device populated with the data path instructions that are indexable by conditional addresses, wherein the second control store memory device is configured to locate a second set of the data path instructions corresponding to at least one conditional address; and
a selection circuit to select between the first set of the data path instructions and the second set of the data path instructions, wherein the selected set of the data path instructions, when executed, are configured to direct digital signal processing operations.

2. The device of claim 1, further comprising a control state machine populated with one or more of the control store addresses and one or more of the conditional addresses, wherein the control state machine is configured to provide the at least one control store address to the first control store memory device and to provide the at least one conditional address to the second control store memory device.

3. The device of claim 2, wherein the selection circuit is configured to select the data path instructions according to a selection signal from the control state machine.

4. The device of claim 3, wherein the execution of the set of the data path instructions selected by the selection circuit identifies an end of block condition, wherein the end of block condition is configured to prompt the control state machine to issue another selection signal to resolve another selection between sets of the data path instructions subsequently identified in the first and second control store memory devices.

5. The device of claim 2, further comprising:
a first program counter to receive the at least one control store address and the at least one conditional address from the control state machine; and
a second program counter to receive both the at least one control store address and the at least conditional address from the control state machine, where the control state machine is configured to direct the first program counter to provide the at least one control store address to the first control store memory device and to direct the second program counter to provide the at least one conditional address to the second control store memory device.

6. The device of claim 1, further comprising a data path device to perform digital filtering operations on digital data according to the data path instructions.

7. The device of claim 6, wherein the data path instructions include one or more control signals capable of reconfiguring the data path device to perform specific digital filtering operations on the digital data.

8. The device of claim 6, wherein the data path instructions include at least one address control signal to identify one or more filter coefficients for the data path device to utilize when performing digital filtering operations on the digital data.

9. A method comprising:
receiving at least one control store address and at least one conditional address from a control state machine;
locating a first set of data path instructions in a first control store memory device according to the at least one control store address;
locating a second set of data path instructions in a second control store memory device according to the at least one conditional address; and
selecting between the first set of data path instructions and the second set of data path instructions, wherein the selected set of data path instructions, when executed, are configured to direct digital processing operations.

10. The method of claim 9, further comprising:
receiving a selection signal from a control state machine; and
selecting between the first set of data path instructions and the second set of data path instructions according to the selection signal from the control state machine.

11. The method of claim 9, further comprising:
identifying an end of block condition responsive to the execution of the selected set of data path instructions, wherein the end of block condition is configured to prompt the control state machine to issue another selection signal to resolve another selection between sets of data path instruction subsequently identified in the first and second control store memory devices.

12. The method of claim 9, further comprising:
directing a first program counter to provide one of the at least one control store address or the at least one conditional address to the first control store memory device; and
directing a second program counter to provide the other one of the at least one control store address or the at least one conditional address to the second control store memory device.

13. The method of claim 9, wherein the data path instructions include one or more control signals capable of reconfiguring a data path device to perform digital processing operations on the digital data.

14. The method of claim 9, wherein the data path instructions include at least one address control signal to identify one or more filter coefficients for a data path device to utilize when performing the digital processing operations on the digital data.

15. A system comprising:
a control store memory that is reconfigurable to populate with multiple sets of data path instructions indexable by control store addresses and jump addresses;
a control state machine to provide at least one control store address and at least one jump address to the control store memory, wherein the control store memory is configured to identify a first set of data path instructions according to the at least one control store address and a second set of data path instructions according to the at least one jump address; and
a data path device to perform digital processing operations on digital data according to one of the first set of data path instructions identified by the at least one control store address or the first set of data path instructions identified by the at least one jump address.

16. The system of claim 15, wherein the control store memory further comprises:
a first memory device populated with multiple sets of data path instructions that are indexable by control store addresses and jump addresses, wherein the first memory device is configured to identify the first set of data path instructions for one of the at least one control store address and the at least one jump address; and
a second memory device populated with multiple sets of data path instructions that are indexable by control store addresses and jump addresses, wherein the second memory device is configured to identify the second set of data path instructions for the other one of the at least one control store address and the at least one jump address.

17. The system of claim 16, wherein the control store memory further comprising a selection circuit to select between the first set of data path instructions located by the first memory device and the second set of data path instructions located by the second memory device, wherein the selected set of data path instructions, when executed, are configured to direct the data path device to perform the digital processing operations.

18. The system of claim 17, wherein the selection circuit is configured to select between the first and second sets of data path instructions according to a selection signal from the control state machine.

19. The system of claim 17, wherein the execution of the set of data path instructions selected by the selection circuit identifies an end of block condition, wherein the end of block condition is configured to prompt the control state machine to issue another selection signal to resolve another selection between sets of data path instruction subsequently identified in the first and second control store memory devices.

20. The system of claim 15, wherein the control store memory further comprising:
a first program counter to receive both the at least one control store address and the at least one jump address from the control state machine; and
a second program counter to receive both the at least one control store address and the at least one jump address from the control state machine, where the control state machine is configured to direct the first program counter to provide the at least one control store address to the first memory device and to direct the second program counter to provide the at least one jump address to the second memory device.
